(19) United States
(12) Patent Application Publication
(10) Pub. No.: US 2024/0136567 A1
(43) Pub. Date: Apr. 25, 2024

(54) ORGANIC-INORGANIC COMPOSITE SOLID POLYMER ELECTROLYTE, INTEGRATED ELECTRODE STRUCTURE AND ELECTROCHEMICAL ELEMENT INCLUDING SAME, AND METHOD FOR PRODUCING ORGANIC-INORGANIC COMPOSITE SOLID POLYMER ELECTROLYTE

(71) Applicant: GRINERGY CO.LTD., Seoul (KR)

(72) Inventor: Hansol Park, Seoul (KR)

(21) Appl. No.: 17/768,424

(22) PCT Filed: Oct. 17, 2019
(86) PCT No.: PCT/KR2019/013644

§ 371 Date: Apr. 12, 2022

(51) Int. Cl. H01M 10/056; H01M 4/38; H01M 10/052

(52) U.S. Cl. CPC H01M 10/056; H01M 4/382; H01M 10/052; H01M 2300/0071; H01M 2300/0082

(57) ABSTRACT

Provided are an organic-inorganic composite solid polymer electrolyte, an integrated electrode structure and an electrochemical device which include the same, and a method of preparing the organic-inorganic composite solid polymer electrolyte. The organic-inorganic composite solid polymer electrolyte includes: an inorganic lithium ion conductor; a copolymer of a crosslinkable precursor including a urethane-containing polyfunctional acrylic monomer and a polyfunctional block copolymer; and a lithium salt, and thus may have improved ion conductivity, mechanical characteristics, and electrochemical stability. In particular, the organic-inorganic composite solid polymer electrolyte having room-temperature ion conductivity of about 10⁻⁴ S/cm may be used in various electrochemical devices.

### TECHNICAL FIELD

One or more embodiments relate to an organic-inorganic composite solid polymer electrolyte, an integrated electrode structure and an electrochemical device that include the organic-inorganic composite solid polymer electrolyte, and a method of preparing the organic-inorganic composite solid polymer electrolyte.

### BACKGROUND ART

Along with the trends towards lighter, slimmer, and more compact electrical and electronic products with improved portability, there is demand for lighter and smaller secondary batteries, which are core components, and there is a demand for the development of batteries with improved power output and improved energy density. Recently, lithium metal secondary batteries have received significant attention as one of the new advanced high-performance next-generation batteries meeting such needs.

However, since a lithium metal electrode used as an electrode in such batteries is highly reactive to an electrolyte component, a passive film is formed by reaction with the organic electrolyte, and as oxidation (dissolution) and reduction (deposition) reactions of lithium on the lithium metal surface during charging and discharging are repeated unevenly, the formation and growth of the passive film are extremely severe. As a result, not only is the capacity of the battery reduced during charging and discharging but, as the charging and discharging process is repeated, lithium ions are grown in the form of needles on the surface of the lithium metal to thereby form dendrites, which shorten the charging and discharging cycles of the lithium secondary battery, resulting in a short circuit between the electrodes.

In order to solve this problem, Korean Patent Laid Open Publication No. 10-2006-0132763 suggested a technique of preparing a solid electrolyte film having characteristics of improved ion conductivity, mechanical characteristics, convenience in process, and electrochemical stability, as compared to those of solid electrolytes of the related art, but due to the characteristics of a chain-type polymer such as polyethyleneoxide methacrylate (PEOMA), when an amount of an inorganic additive is about 40 weight % to about 50 weight %, the electrolyte film may not be substantially effective.

In the case of Korean Patent No. 10-1793168, polymers used in preparation of a composite solid electrolyte are materials having very low ion conductivity at room temperature, such as polyethylene oxide, polyethylene glycol, polypropylene oxide, polysiloxane, and polyphosphazene, which makes it difficult to use them at room temperature. Thus, a battery including a composite solid electrolyte is expected to be usable at a temperature of 50° C. or higher.

Typically, PEO is a commonly known ion-conductive polymer but has a room-temperature ion conductivity of about 10⁻⁷ S/cm and thus cannot be used in a battery utilized at room temperature. The electrolyte is a polymer electrolyte that may be operated at a high temperature of 60° C. or higher, which is a glass transition temperature (Tg) of PEO. When the polymer and an inorganic ceramic material having an ion conductivity of about 10⁻⁴ S/cm are combined, the room-temperature ion conductivity is deemed to be further lowered.

In order to resolve this issue, there is a need to study and develop an organic-inorganic composite electrolyte that may improve room-temperature ion conductivity and mechanical strength without degradation or with minimal degradation of ion conductivity of LLZO, LPS, LGPS, or other inorganic ceramic materials having excellent ion conductivity.

### DESCRIPTION OF EMBODIMENTS

### Technical Problem

One or more embodiments include an organic-inorganic composite solid polymer electrolyte that may improve room-temperature ion conductivity and secure mechanical strength without degradation or with minimal degradation of ion conductivity of an inorganic lithium ion conductor on a lithium metal electrode surface.

One or more embodiments include an integrated electrode structure, in which the organic-inorganic composite solid polymer electrolyte is used.

One or more embodiments include an electrochemical device, in which the organic-inorganic composite solid polymer electrolyte is used.

One or more embodiments include a method of preparing the organic-inorganic composite solid polymer electrolyte.

### Solution to Problem

According to one or more embodiments,
an organic-inorganic composite solid polymer electrolyte includes:
an inorganic lithium ion conductor;
a copolymer of a crosslinkable precursor including a urethane-containing polyfunctional acrylic monomer and a polyfunctional block copolymer; and a lithium salt.

According to one or more embodiments,
an integrated electrode structure includes a lithium metal electrode; and the solid polymer electrolyte on the lithium metal electrode.

According to one or more embodiments,
an electrochemical device includes the electrode structure. According to one or more embodiments,
a method of preparing the organic-inorganic composite solid polymer electrolyte includes
preparing a precursor mixture including an inorganic lithium ion conductor, a crosslinkable precursor including a urethane-containing polyfunctional acrylic monomer and a polyfunctional block copolymer, and a lithium salt; and applying and curing the precursor mixture in a film form.

### Advantageous Effects of Disclosure

An organic-inorganic composite solid polymer electrolyte according to an embodiment has high elasticity and high strength characteristics, which may exhibit high ion conductivity and mechanical strength at room temperature without degradation of ion conductivity of an inorganic lithium ion conductor used therein, and the organic-inorganic composite solid polymer electrolyte may be prepared in a large area without pressing in the preparation of an electrolyte film. The organic-inorganic composite solid polymer may be used in various electrochemical devices, such as lithium metal secondary batteries, and thus may improve their performance.

### BRIEF DESCRIPTION OF DRAWINGS

FIG. 1 is a graph that shows the results of measuring ion conductivity of organic-inorganic composite solid polymer electrolyte films prepared in Examples 1 to 3 and Comparative Example 1 at room temperature; and

FIG. 2 is a graph that shows the results of measuring ion conductivity of the organic-inorganic composite solid polymer electrolyte films prepared in Examples 1 to 3 and Comparative Example 1 according to temperature change.

### MODE OF DISCLOSURE

As the present inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope of the present inventive concept are encompassed in the present inventive concept.

The terms used in the present specification are merely used to describe particular embodiments, and are not intended to limit the present inventive concept. An expression used in the singular encompasses the expression of the plural, unless it has a clearly different meaning in the context. In the present specification, it is to be understood that the terms such as “comprises” and/or “comprising,” or “includes” and/or “including”, “having,” or the like, are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added. As used herein, “/” may be construed as referring to “and” or “or” depending on the context.

In the drawings, diameters, lengths, and thicknesses of components, layers, and regions are exaggerated or reduced for clarity. Like reference numerals in the drawings and specification denote like elements. In the present specification, it will be understood that when an element, e.g., a layer, a film, a region, or a substrate, is referred to as being “on” or “above” another element, it may be directly on the other element or intervening layers may also be present. While such terms as “first,” “second,” or the like, may be used to describe components, such components must not be limited to the above terms. These terms are used only to distinguish one component from another. In the drawings, some of the components may be omitted to facilitate understanding of the features of the present inventive concept, but the present inventive concept is not intended to exclude the omitted components.

As used herein, when specific definition is not otherwise provided, “substituted” refers to replacement of at least one hydrogen atom of a compound by a substituent of a halogen atom (F, Cl, Br, or I), a C1 to C20 alkoxy group, a nitro group, a cyano group, an amine group, an imino group, an azido group, an am idino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

As used herein, when specific definition is not otherwise provided, “hetero” refers to one including at least one heteroatom selected from N, O, S, or P in a chemical formula.

As used herein, when specific definition is not otherwise provided, “(meth)acrylate” refers to both “acrylate” and “methacrylate”, and “(meth)acrylic acid” refers to both “acrylic acid” and “methacrylic acid”.

Hereinafter, an organic-inorganic composite solid polymer electrolyte according to an embodiment, an electrode structure and an electrochemical device that include the organic-inorganic composite solid polymer electrolyte, and a method of preparing the organic-inorganic composite solid polymer electrolyte will be described in detail with reference to the attached drawings.

An organic-inorganic composite solid polymer electrolyte according to an embodiment includes:
an inorganic lithium ion conductor;
a copolymer of a crosslinkable precursor including a urethane-containing polyfunctional acrylic monomer and a polyfunctional block copolymer; and
a lithium salt.

The organic-inorganic composite solid polymer electrolyte may include an inorganic lithium ion conductor in the form of particles embedded in a polymer matrix, which is a copolymer having a crosslinkable structure prepared with a urethane-containing polyfunctional acrylic monomer and a polyfunctional block copolymer as a main chain. When the organic-inorganic composite solid polymer electrolyte is used, not only mechanical characteristics of the copolymer itself may be excellent, but also the form of a film may be maintained without losing an inorganic lithium ion conductor when the inorganic lithium ion conductor is mixed at a large amount, and excellent ion conductivity may be secured.

In the organic-inorganic composite solid polymer electrolyte, the inorganic lithium ion conductor may include at least one selected from oxide-based, phosphate-based, sulfide-based, and LiPON-based inorganic materials that have lithium ion conductivity.

The inorganic lithium ion conductor may be, for example, at least one selected from the group consisting of a garnet compound, an argyrodite compound, a lithium super-ion-conductor (LISICON) compound, a Na super ionic conductor-like (NASICON) compound, a lithium nitride (Li nitride), a lithium hydride (Li hydride), a perovskite compound, a lithium halide (Li halide), and a sulfide-based compound.

The inorganic lithium ion conductor may include, for example, at least one selected from garnet ceramic, Li₃₊ₓLa₃M₂O₁₂ (where 0≤x≤5, and M is at least one of W, Ta, Te, Nb, and Zr), doped garnet ceramic, Li₇₋₃ₓM′ₓLa₃M₂O₁₂ (where 0<x≤1, M is at least one of W, Ta, Te, Nb, and Zr, and M′ is at least one of Al, Ga, Nb, Ta, Fe, Zn, Y, Sm, and Gd), Li_{1+x+y}AlₓTi₂₋ₓSi_{y}P_{3-y}O₁₂ (where 0<x<2 and 0≤y<3), BaTiO₃, Pb(Zr,Ti)O₃ (PZT), Pb₁₋ₓLaₓZr_{1-y}Ti_{y}O₃ (PLZT, where 0≤x<1 and 0≤y<1), Pb(Mg_{1/3}Nb_{2/3})O₃-PbTiO₃ (PMN-PT), lithium phosphate (Li₃PO₄), lithium titanium phosphate (LiₓTi_{y}(PO₄)₃, where 0<x<2 and 0<y<3), lithium aluminum titanium phosphate (LiₓAl_{y}Ti_{z}(PO₄)₃, where 0<x<2, 0<y<1, and 0<z<3), Li_{1+x+y}(Al, Ga)ₓ(Ti, Ge)₂₋ₓSi_{y}P_{3-y}O₁₂ (where 0≤x≤1 and 0≤y≤1), lithium lanthanum titanate (LiₓLa_{y}TiO₃, where 0<x<2 and 0<y<3), lithium germanium thiophosphate(LiₓGe_{y}P_{z}S_{w}, where 0<x<4, 0<y<1, 0<z<1, and 0<w<5), lithium nitride (LiₓN_{y}, where 0<x<4 and 0<y<2), SiS₂-base glass (LiₓSi_{y}S_{z}, where 0≤x<3, 0<y<2, and 0<z<4), P₂S₅-base glass (LiₓP_{y}S_{z}, where 0≤x<3, 0<y<3, and 0<z<7), Li₃ₓLa_{2/3-x}TiO₃ (where 0≤x≤⅙), Li₇La₃Zr₂O₁₂, Li_{1+y}Al_{y}Ti_{2-y}(PO₄)₃(where 0≤y≤1), Li_{1+z}Al_{z}Ge_{2-z}(PO₄)₃ (where 0≤z≤1), Li₂O, LiF, LiOH, Li₂CO₃, LiAlO₂, Li₂O-Al₂O₃-SiO₂-P₂O₅-TiO₂-GeO₂-based ceramic, Li₁₀GeP₂S₁₂, Li_{3.25}Ge_{0.25}P_{0.75}S₄, Li₃PS₄, Li₆PS₅Br, Li₆PS₅Cl, Li₇PS₅, Li₆PS₅I, Li_{1.3} Al_{0.3}Ti_{1.7}(PO₄)₃, LiTi₂(PO₄)₃, LiGe₂(PO₄)₃, LiHf₂(PO₄)₃, LiZr₂(PO₄)₃, Li₂NH₂, Li₃(NH₂)₂I, LiBH₄, LiAlH₄, LiNH₂, Li_{0.34}La_{0.51}TiO_{2.94}, LiSr₂Ti₂NbO₉, Li_{0.06}La_{0.66}Ti_{0.93}Al_{0.03}O₃, Li_{0.34}Nd_{0.55}TiO₃, Li₂CdCl₄, Li₂MgCl₄, Li₂ZnI₄, Li₂CdI₄, Li_{4.9}Ga_{0.5+δ}La₃Zr_{1.7}W_{0.3}O₁₂ (where 0≤δ<1.6), Li_{4.9}Ga_{0.5+δ}La₃Zr_{1.7}W_{0.3}O₁₂ (where 1.7≤δ≤2.5), Li_{5.39}Ga_{0.5+δ}La₃Zr_{1.7}W_{0.3}O₁₂ (where 0≤δ≤1.11), lithium phosphorous sulfide (Li₃PS₄), lithium tin sulfide (Li₄SnS₄), lithium phosphorous sulfur chloride iodide (Li₆PS₅Cl_{0.9}I_{0.1}), lithium tin phosphorus sulfide (Li₁₀SnP₂S₁₂), Li₂S, Li₂S-P₂S₅, Li₂S-SiS₂, Li₂S-GeS₂, Li₂S-B₂S₅, and Li₂S-Al₂S₅.

For example, the inorganic lithium ion conductor may be garnet-type LLZO or Al-doped lithium lanthanum zirconium oxide (Li₇₋₃ₓAlₓLa₃Zr₂O₁₂) (where 0<x≤1), the analogous oxide-type solid electrolyte may be lithium lanthanum titanate (LLTO) (Li_{0.34}La_{0.51}TiOy) (where 0<y≤03) or lithium aluminum titanium phosphate (LATP) (Li_{1.3}Al_{0.3}Ti_{1.7}(PO₄)₃), and the sulfide may be lithium phosphorus sulfide (LPS) (Li₃PS₄), lithium tin sulfide (LTS) (Li₄SnS₄), lithium phosphorus sulfur chloride iodide (LPSCLI) (Li₆PS₅Cl_{0.9}I_{0.1}), or lithium tin phosphorus sulfide (LSPS) (Li₁₀SnP₂S₁₂).

In some embodiments, the inorganic lithium ion conductor may include garnet-type ceramic represented by Formula 3 or aluminum-doped ceramic represented by Formula 4.

LiₓLa_{y}Zr_{z}O₁₂ Formula 3

In Formula 3, 6<x<9, 2<y<4, and 1<z<3.

LiₓLa_{y}Zr_{z}Al_{w}O₁₂ Formula 4

In Formula 4, 5<x<9, 2<y<4, 1<z<3, and 0<w<I.

The inorganic lithium ion conductor may have a particle or columnar structure.

In the organic-inorganic composite solid polymer electrolyte, a grain of the inorganic lithium ion conductor may have a polyhedral shape. In the case of a grain having a polyhedral shape, the contact area between adjacent grains may increase, thereby decreasing ion conductivity resistance and increasing the possibility of contact between an active material and a crystal plane efficient for a charge transfer reaction, thereby increasing the kinetics of an electrochemical reaction.

The inorganic lithium ion conductor may have an average particle diameter in a range of about 10 nm to about 30 μm. For example, an average particle diameter of the inorganic lithium ion conductor may be in a range of about 100 nm to about 20 μm, about 200 nm to about 10 μm, about 300 nm to about 1 μm, or about 400 nm to about 600 nm. When the average particle diameter is within these ranges, a film thickness of the solid polymer electrolyte may be reduced while facilitating the dispersion in a precursor solution.

An amount of the inorganic lithium ion conductor may be in a range of about 30 weight % (wt %) to about 90 wt %, about 40 wt % to about 85 wt %, or about 50 wt % to about 80 wt %, based on a total weight of the inorganic lithium ion conductor and the copolymer. When the amount of the inorganic lithium ion conductor is within these ranges, the organic-inorganic composite solid polymer electrolyte having high lithium ion conductivity may be provided, and making a composite with the copolymer may be possible. Even when the amount of the inorganic lithium ion conductor is as high as higher than 50 wt %, based on a total weight of the inorganic lithium ion conductor and the copolymer, the organic-inorganic composite solid polymer electrolyte may exhibit high ion conductivity.

In the organic-inorganic composite solid polymer electrolyte, the copolymer of a crosslinkable precursor including a urethane-containing polyfunctional acrylic monomer and a polyfunctional block copolymer controls crystallinity of a polymer to maintain an amorphous state and improves ion conductivity and electrochemical characteristics. In the crosslinkable matrix prepared with a urethane-containing polyfunctional acrylic monomer and a polyfunctional block copolymer in a main chain, crystallization of the polymer itself is very low, and migration of lithium ions due to segmental motion of the polymer in an amorphous region in the matrix is free, which may improve ion conductivity. Also, the polymer crosslinkable structure in the copolymer may improve mechanical characteristics of the copolymer itself, disperse inorganic lithium ions in the polymer matrix, and not lose the ions from the polymer.

As the crosslinkable precursor, the urethane-containing polyfunctional acrylic monomer may include diurethane dimethacrylate, diurethane diacrylate, or a combination thereof.

In some embodiments, the urethane-containing polyfunctional acrylic monomer may include diurethane dimethacrylate represented by Formula 1.

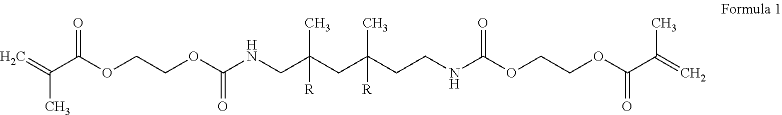

In Formula 1, each R is independently a hydrogen atom or a C1-C3 alkyl group.

Since the urethane-containing polyfunctional acrylic monomer has high mechanical strength and elasticity by including a urethane moiety, when a copolymer structure is formed using the urethane-containing polyfunctional acrylic monomer and a polyfunctional block copolymer, an organic-inorganic composite solid polymer electrolyte having elasticity and maintaining the high mechanical strength may be prepared.

Other monomer including a polyfunctional functional group having a structure similar to that of the urethane-containing polyfunctional acrylic monomer may be added and mixed to be used together with the urethane-containing polyfunctional acrylic monomer. Examples of the other monomers including a polyfunctional functional group may include at least one selected from the group consisting of urethane acrylate methacrylate, urethane epoxy methacrylate, and Satomer N3DE180 and N3DF230 available from Arkema.

As the crosslinkable precursor, the polyfunctional block copolymer may include a (meth)acrylate group at both ends and may include a diblock copolymer or triblock copolymer including a polyethylene oxide repeating unit and a polypropylene oxide repeating unit.

In some embodiments, the polyfunctional block copolymer may include a (meth)acrylate group at both ends and may include a triblock copolymer consisting of a first block of polyethylene oxide, a second block of polypropylene oxide, and a third block of polyethylene oxide.

In some embodiments, the polyfunctional block copolymer may be represented by Formula 2.

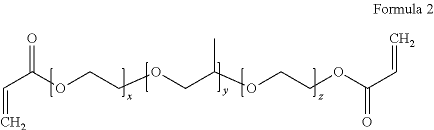

In Formula 2, x, y, and z are each independently an integer of 1 to 50.

The polyfunctional block copolymer having the above structure may be structurally similar to commonly known polyethylene glycol dimethacrylate (PEGDMA), but in the case of PEGDMA, a degree of crystallinity is high due to the single linear structure, and breaking phenomenon may occur according to a degree of crosslinking after the crosslinking polymerization, whereas the polyfunctional block copolymer has a block copolymer structure of propylene oxide and ethylene oxide which destroys crytallinity that appears in a single structure of ethylene oxide, and may add flexibility to an organic-inorganic composite solid polymer electrolyte due to the two different polymer blocks.

A weight average molecular weight (Mw) of the polyfunctional block copolymer may be in a range of about 500 to about 20,000. For example, a weight average molecular weight (Mw) of the polyfunctional block copolymer may be in a range of about 1,000 to about 20,000 or about 1,000 to about 10,000. When the weight average molecular weight (Mw) of the polyfuctional block copolymer is within these ranges, the length of the block copolymer itself is appropriate that may not change the polymer to brittle, and a viscosity and a thickness may be easily controlled during coating of a lithium metal electrode not using a solvent.

A weight ratio of the urethane-containing polyfunctional acrylic monomer and the polyfunctional block copolymer may be in a range of about 1:100 to about 100:1. For example, a weight ratio of the urethane-containing polyfunctional acrylic monomer and the polyfunctional block copolymer may be in a range of about 1:10 to about 10:1. For example, a weight ratio of the urethane-containing polyfunctional acrylic monomer and the polyfunctional block copolymer may be in a range of about 1:5 to about 5:1. When the weight ratio is within these ranges, crystallinity of the polymer may be controlled to maintain an amorphous state and may improve ion conductivity and electrochemical characteristics.

Other monomers or polymers having structures similar to that of the polyfunctional block copolymer may be additionally mixed to the polyfunctional block copolymer. Examples of the other monomers or polymers may include one or more selected from dipentaerythritol penta-/hexa-acrylate, glycerol propoxylate triacrylate, di(trimethylolpropane) tetraacrylate, trimethylolpropane ethoxylate triacrylate, and poly(ethylene glycol) methyl ether acrylate, but embodiments are not limited thereto.

The lithium salt secures an ion conduction path of the organic-inorganic composite solid polymer electrolyte. The lithium salt may be any material that may be commonly used as a lithium salt in the art. For example, the lithium salt may include at least one selected from LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂, but embodiments are not limited thereto.

An amount of the lithium salt in the organic-inorganic composite solid polymer electrolyte is not particularly limited but may be, for example, in a range of about 1 wt % to about 50 wt %, based on a total weight of the copolymer and the lithium salt, except the inorganic lithium ion conductor. For example, an amount of the lithium salt may be in a range of about 5 wt % to about 50 wt % or, particularly, about 10 wt % to about 30 wt %, based on a total weight of the copolymer and the lithium salt. When the amount of the lithium salt is within these ranges, lithium ion mobility and ion conductivity may be excellent.

When the organic-inorganic composite solid polymer electrolyte includes the inorganic lithium ion conductor as an inorganic material; the copolymer of a crosslinkable precursor including a urethane-containing polyfunctional acrylic monomer and a polyfunctional block copolymer as an organic material; and the lithium salt, the crystallinity of the polymer may be controlled to maintain an amorphous state, and ion conductivity and electrochemical characteristics may be improved. Also, mechanical and elastomeric properties of the copolymer itself may be improved by the organic-inorganic composite crosslinking structure, an organic-inorganic composite solid polymer electrolyte film having excellent mechanical properties may be prepared using only a small amount of an organic material.

The organic-inorganic composite solid polymer electrolyte in a film form may be used as an all-solid electrolyte that does not use liquid and may improve ion conductivity, mechanical characteristics, and electrochemical stability as compared to those of a polymer electrolyte of the related art and, particularly, have room-temperature ion conductivity of about 10⁻⁴ S/cm or higher. An ion conductivity (σ) of the organic-inorganic composite solid polymer electrolyte may be in a range of about 4×10⁻⁴ S/cm to about 6×10⁻⁴ S/cm at room temperature in a range of about 25° C. to about 70° C.

The organic-inorganic composite solid polymer electrolyte may be prepared by forming the electrolyte a film of a free standing form or directly coating the electrolyte on a lithium metal electrode to minimize an interface between the lithium metal electrode and the solid polymer electrolyte.

As described above, the organic-inorganic composite solid polymer electrolyte may have excellent ion conductivity and mechanical strength and may provide an electrolyte film that may be used in an electrochemical device such as a lithium secondary battery of high-density and high-energy using a lithium metal electrode. Also, when the organic-inorganic composite solid polymer electrolyte is used, leakage of electrolyte and electrochemical side reactions between an anode and a cathode do not occur, and unlike an electrolyte using a liquid electrolyte, electrolyte decomposition reaction may not occur, but improvement of battery characteristics and stability of the battery may be secured.

According to another embodiment, an integrated electrode structure may include:
a lithium metal electrode; and
the organic-inorganic composite solid polymer electrolyte on the lithium metal electrode.

A thickness of the lithium metal electrode may be about 100 μm or less, for example, about 80 μm or less, about 50 μm or less, about 30 μm or less, or about 20 μm or less. In some embodiments, a thickness of the lithium metal electrode may be in a range of about 0.1 μm to about 60 μm. In some embodiments, a thickness of the lithium metal electrode may be in a range of about 1 μm to about 25 μm, for example, about 5 μm to about 20 μm.

The organic-inorganic composite solid polymer electrolyte is located on the lithium metal electrode and is integrated with the lithium metal electrode. The organic-inorganic composite solid polymer electrolyte has high ion conductivity and mechanical strength even at room temperature and a high temperature, and thus performance of the lithium metal electrode may be improved.

The electrochemical device according to another embodiment includes the organic-inorganic composite solid polymer electrolyte.

When the electrochemical device uses the organic-inorganic composite solid polymer electrolyte, the electrochemical device may have excellent safety and high energy density, maintain battery characteristics at a temperature of about 60° C. or higher, and allow operation of all electronic products at such high temperature.

The electrochemical device may be a lithium secondary battery such as a lithium ion battery, a lithium polymer battery, a lithium air battery, or a lithium all-solid battery.

The electrochemical device including the organic-inorganic composite solid polymer electrolyte may be used in applications requiring high capacity, high power output, and high-temperature driving, such as electric vehicles, in addition to existing mobile phones and portable computers, and may be combined with an existing internal-combustion engine, a fuel cell, or a super capacitor to be used in hybrid vehicles. Also, the electrochemical device may be used in any applications that require high power output, high voltage, and high-temperature driving.

Hereinafter, according to another embodiment, a method of preparing the organic-inorganic composite solid polymer electrolyte will be described.

The method of preparing the organic-inorganic composite solid polymer electrolyte includes:
preparing a precursor mixture including an inorganic lithium ion conductor, a crosslinkable precursor including a urethane-containing polyfunctional acrylic monomer and a polyfunctional block copolymer, and a lithium salt; and
applying and curing the precursor mixture in a film form.

In the related art, an inorganic solid electrolyte is generally prepared in a pellet form by applying a pressure of about 1.0 MPa or higher to an inorganic material, e.g., LLZO, but the organic-inorganic composite solid polymer electrolyte according to an embodiment may be prepared in a film form by making a composite of an inorganic lithium ion conductor with a polymer without applying a pressure to prepare an organic-inorganic composite solid polymer electrolyte.

The inorganic lithium ion conductor, the crosslinkable precursor including a urethane-containing polyfunctional acrylic monomer and a polyfunctional block copolymer, and the lithium salt are the same as those described above.

The precursor mixture may further include a crosslinking agent or a photoinitiator to facilitate crosslinking of the crosslinkable precursor. Amounts of the crosslinking agent and photoinitiator may be in conventional ranges, which may be, for example, in a range of about 1 part to about 5 parts by weight based on 100 parts by weight of the crosslinkable precursor.

In some embodiments, the precursor mixture may further include an initiator to form a copolymer having a structure in which a crosslinking agent is crosslinked. The initiator may be a thermal initiator, and examples of the initiator may include peroxides (—O—O—), such as benzoyl peroxide, acetyl peroxide, dilauryl peroxide, di-tert-butyl peroxide, and cummyl hydroperoxide; and azo-based compounds (—N═N—) such as azobisisobutyronitrile and azobisisovaleronitrile.

A method of mixing precursor materials such as the inorganic lithium ion conductor, the crosslinkable precursor, and the lithium salt may vary. For example, the precursor materials may be mixed by ball milling, using mortar and pestel, or ultrasonic homogenizer mixing, but embodiments are not limited thereto.

Once the precursor mixture including the inorganic lithium ion conductor, the crosslinkable precursor, and the lithium salt is prepared, the precursor mixture may be applied and cured in a film form to form an organic-inorganic composite solid polymer electrolyte. The precursor mixture may be applied in a film form while including the crosslinkable precursor, optionally an initiator, and the lithium salt without using a solvent.

A method of applying the precursor mixture in a film form may vary, and the method is not particularly limited. For example, the precursor mixture may be injected between two glass plates, and a constant pressure may be applied to the glass plates using a clamp to control a thickness of the electrolyte film. In some embodiments, the precursor mixture may be directly applied on a lithium metal electrode using a coating device such as spin coating to form a thin film having a predetermined thickness.

A process of applying the precursor mixture may be performed using doctor blade, drop casting, and equipment for pressing glass plates.

A method of curing the precursor mixture may be, for example, a curing method using UV, heat, or high energy radiation (electron beam, γ-ray). In some embodiments, 365 nm of UV may be directly irradiated on the precursor mixture, or the precursor mixture may be thermal polymerized and crosslinked at about 60° C. to prepare an organic-inorganic composite solid polymer electrolyte.

Through this process, an organic-inorganic composite solid polymer electrolyte film in a monolith form may be prepared.

Hereinafter, example embodiments will be described in detail with reference to Examples and Comparative Examples. However, these examples are provided for illustrative purposes only and are not intended to limit the scope of the present inventive concept.

### Example 1

5 g of garnet-type Al-doped LLZO (Li₇AlₓLa₃Zr₂O₁₂, particle size: 500 nm or less, available from Ampcera Inc.) as an inorganic lithium ion conductor, 1 g of diurethane dimethacrylate (DUDMA) represented by Formula 1 (Mw: 470.56/mol, available from Sigma-Aldrich), and 0.5 g of poly(ethylene glycol)-block-poly(propylene glycol)-block-poly(ethylene glycol) diacrylate (PPG-b-PEG) represented by Formula 2 (average Mn: 1200 or less, available from Sigma-Aldrich) were mixed for about 20 minutes using mortar and pestle, and 0.65 g of lithium bis(fluorosulfonyl)imide (LiFSI) as a lithium salt in a vial was mixed thereto. 240.30 g/mol of benzoin ethyl ether (BEE) (available from Sigma-Aldrich) as an initiator was added and mixed to the mixture at an amount of 3%, based on a total weight of the monomer to prepare a composite solid electrolyte precursor mixture.

0.2 g of the composite solid electrolyte precursor mixture was placed on a glass plate and covered with another glass plate. Then, the mixture was irradiated with 365 nm UV for 50 seconds to prepare an organic-inorganic composite solid polymer electrolyte film having a thickness in a range of 30 μm to 50 μm.

### Example 2

An organic-inorganic composite solid polymer electrolyte film was prepared in the same manner as in Example 1, except that amounts of LLZO, DUDMA, and PPG-b-PEG in Example 1 were changed to 3 g, 1 g, and 0.5 g, respectively.

### Example 3

An organic-inorganic composite solid polymer electrolyte film was prepared in the same manner as in Example 1, except that amounts of LLZO, DUDMA, and PPG-b-PEG in Example 1 were changed to 2 g, 1 g, and 0.5 g, respectively.

### Comparative Example 1

An organic-inorganic composite solid polymer electrolyte film was prepared in the same manner as in Example 1, except that LLZO in Example 1 was not used, and amounts of DUDMA and PPG-b-PEG in Example 1 were changed to 4 g and 2 g, respectively.

### Evaluation Example 1: Ion Conductivity Evaluation

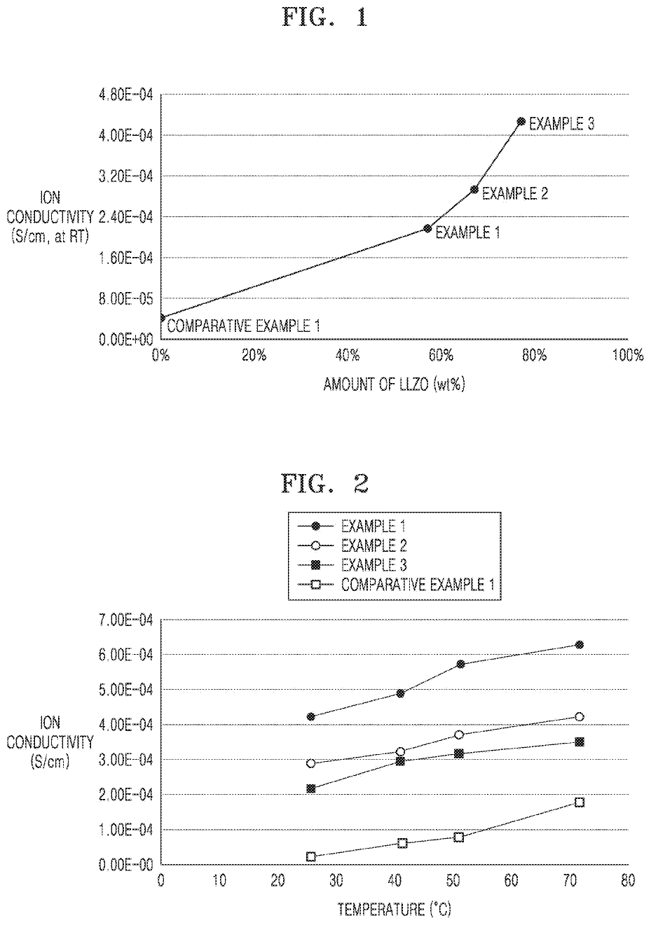

Ion conductivities of the organic-inorganic composite solid polymer electrolyte films prepared in Examples 1 to 3 and Comparative Example 1 were measured, and the results are shown in Table 1 and FIG. 1. The ion conductivities were measured at a frequency of 1 Hz to 1 MHz using a solatron 1260A Impedance/Gain-Phase Analyzer after placing a sample between two sus disks, each having an area of 1 cm², and applying a constant pressure to the sus disks using springs at both ends.

TABLE 1

| | | | | Comparative |
|---|---|---|---|---|
| | Example 1 | Example 2 | Example 3 | Example 1 |
| LLZO/DUDMA/ | 5 g/1 g/0.5 g | 3 g/1 g/0.5 g | 2 g/1 g/0.5 g | 0 g/4 g/2 g |
| PPG-b-PEG | | | | |
| Room-temper- | 4.24 × 10⁻⁴ | 2.93 × 10⁻⁴ | 2.91 × 10⁻⁴ | 1.23 × 10⁻⁵ |
| ature ion | | | | |
| conductivity | | | | |

As shown in Table 1, the organic-inorganic composite solid polymer electrolyte films prepared in Examples 1 to 3 and Comparative Example 1 had different ion conductivities according to a content ratio of LLZO, and the ion conductivities were as high as 10⁻⁴ S/cm or higher at room temperature. On the other hand, an ion conductivity of a pure organic-inorganic composite solid polymer electrolyte not including an inorganic lithium ion conductor, LLZO, was relatively as high as 10⁻⁵ S/cm at room temperature but was lower than that of the organic-inorganic composite solid polymer electrolyte films including LLZO. States of the organic-inorganic composite solid polymer electrolyte films before and after the ion conductivity measurement did not have significant changes.

### Example 2: Ion Conductivity Evaluation According to Temperature

Ion conductivities of the organic-inorganic composite solid polymer electrolyte films prepared in Examples 1 to 3 and Comparative Example 1 according to temperature change were measured, and the results are shown in Table 2 and FIG. 2.

TABLE 2

| | | | | Comparative |
|---|---|---|---|---|
| Temperature | Example 1 | Example 2 | Example 3 | Example 1 |
| 25° C. | 4.24 × 10⁻⁴ | 2.93 × 10⁻⁴ | 2.19 × 10⁻⁴ | 1.23 × 10⁻⁵ |
| 40° C. | 4.90 × 10⁻⁴ | 3.24 × 10⁻⁴ | 2.95 × 10⁻⁴ | 7.1 × 10⁻⁵ |
| 50° C. | 5.60 × 10⁻⁴ | 3.37 × 10⁻⁴ | 3.22 × 10⁻⁴ | 8.4 × 10⁻⁵ |
| 70° C. | 6.15 × 10⁻⁴ | 4.17 × 10⁻⁴ | 3.51 × 10⁻⁴ | 1.71 × 10⁻⁴ |

As shown in Table 2 and FIG. 2, the ion conductivity of the LLZO-composite organic-inorganic composite solid polymer electrolyte film of Example 1 was about 6.15×10⁻⁴ S/cm at a temperature of 70° C., which is relatively applicable to a battery, whereas the ion conductivity of the LLZO-free organic-inorganic composite solid polymer electrolyte film was about 10⁻⁵ S/cm or less at a temperature of 50° C., which is lower than that of a composite electrolyte including LLZO, and in this case, the electrolyte film may be applicable to a battery only by adding oligomer or other additives to improve the ion conductivity. The organic-inorganic composite solid polymer electrolyte films of Examples 1 to 3 all first showed low ion conductivities of about 10⁻⁴ S/cm or lower, but it is deemed that ion conductivities also increased as hopping and diffusion of ions were activated due to an increase of activation energy of the organic-inorganic composite solid polymer electrolyte films themselves as the temperature increased.

As described above, a composite solid electrolyte according to one or more embodiments prepared using a polyurethane group-containing polymer matrix has excellent room-temperature and high-temperature ion conductivity as compared to those of a solid composite polymer electrolyte prepared using PEO, PVDF, or PEGDMA, which are commonly used as a polymer for a solid electrolyte, as a main chain. In particular, the composite solid electrolyte according to one or more embodiments may be prepared by mixing small amounts of a polymer and an inorganic lithium ion conductor, and it may be confirmed that the composite solid electrolyte has excellent mechanical stability characteristics capable of maintaining a shape and features of a composite polymer electrolyte film without degradation of film characteristics and damages caused by volume expansion.

While one or more embodiments of the present disclosure have been described with reference to the figures and examples, it will be understood by those of ordinary skill in the art that various changes and other equivalent embodiments may be made therein. Therefore, the scope of the present disclosure should be defined by the accompanying claims. CLAIMS

1. An organic-inorganic composite solid polymer electrolyte comprising:
an inorganic lithium ion conductor;
a copolymer of a crosslinkable precursor comprising a urethane-containing polyfunctional acrylic monomer and a polyfunctional block copolymer; and
a lithium salt.

2. The organic-inorganic composite solid polymer electrolyte of claim 1, wherein the inorganic lithium ion conductor is at least one selected from the group consisting of a garnet compound, an argyrodite compound, a lithium super-ion-conductor (LISICON) compound, a Na super ionic conductor-like (NASICON) compound, a lithium nitride (Li nitride), a lithium hydride (Li hydride), a perovskite compound, a lithium halide (Li halide), and a sulfide-based compound.

3. The organic-inorganic composite solid polymer electrolyte of claim 1, wherein the inorganic lithium ion conductor comprises at least one selected from garnet ceramic, Li₃₊ₓLa₃M₂O₁₂ (where 0≤x≤5, and M is at least one of W, Ta, Te, Nb, and Zr), doped garnet ceramic, Li₇₋₃ₓM′ₓLa₃M₂O₁₂ (where 0<x≤1, M is at least one of W, Ta, Te, Nb, and Zr, and M′ is at least one of Al, Ga, Nb, Ta, Fe, Zn, Y, Sm, and Gd), Li_{1+x+y}AlₓTi₂₋ₓSi_{y}P_{3-y}O₁₂ (where 0<x<2 and 0≤y<3), BaTiO₃, Pb(Zr,Ti)O₃ (PZT), Pb₁₋ₓLaₓZr_{1-y}Ti_{y}O₃ (PLZT, where 0≤x<1 and 0≤y<1), Pb(Mg_{1/3}Nb_{2/3})O₃-PbTiO₃ (PMN-PT), lithium phosphate (Li₃PO₄), lithium titanium phosphate (LiₓTi_{y}(PO₄)₃, where 0<x<2 and 0<y<3), lithium aluminum titanium phosphate (LiₓAl_{y}Ti_{z}(PO₄)₃, where 0<x<2, 0<y<1, and 0<z<3), Li_{1+x+y}(Al, Ga)ₓ(Ti, Ge)₂₋ₓSi_{y}P_{3-y}O₁₂ (where 0≤x≤1 and 0≤y≤1), lithium lanthanum titanate (LiₓLa_{y}TiO₃, where 0<x<2 and 0<y<3), lithium germanium thiophosphate(LiₓGe_{y}P_{z}S_{w}, where 0<x<4, 0<y<1, 0<z<1, and 0<w<5), lithium nitride (LiₓN_{y}, where 0<x<4 and 0<y<2), SiS₂-base glass (LiₓSi_{y}S_{z}, where 0≤x<3, 0<y<2, and 0<z<4), P₂S₅-base glass (LiₓP_{y}S_{z}, where 0≤x<3, 0<y<3, and 0<z<7), Li₃ₓLa_{2/3-x}TiO₃ (where 0≤x≤⅙), Li₇La₃Zr₂O₁₂, Li_{1+y}Al_{y}Ti_{2-y}(PO₄)₃(where 0≤y≤1), Li_{1+z}Al_{z}Ge_{2-z}(PO₄)₃ (where 0≤z≤1), Li₂O, LiF, LiOH, Li₂CO₃, LiAlO₂, Li₂O-Al₂O₃-SiO₂-P₂O₅-TiO₂-GeO₂-based ceramic, Li₁₀GeP₂S₁₂, Li_{3.25}Ge_{0.25}P_{0.75}S₄, Li₃PS₄, Li₆PS₅Br, Li₆PS₅Cl, Li₇PS₅, Li₆PS₅I, Li_{1.3} Al_{0.3}Ti_{1.7}(PO₄)₃, LiTi₂(PO₄)₃, LiGe₂(PO₄)₃, LiHf₂(PO₄)₃, LiZr₂(PO₄)₃, Li₂NH₂, Li₃(NH₂)₂I, LiBH₄, LiAlH₄, LiNH₂, Li_{0.34}La_{0.51}TiO_{2.94}, LiSr₂Ti₂NbO₉, Li_{0.06}La_{0.66}Ti_{0.93}Al_{0.03}O₃, Li_{0.34}Nd_{0.55}TiO₃, Li₂CdCl₄, Li₂MgCl₄, Li₂ZnI₄, Li₂CdI₄, Li_{4.9}Ga_{0.5+δ}La₃Zr_{1.7}W_{0.3}O₁₂ (where 0≤δ<1.6), Li_{4.9}Ga_{0.5+δ}La₃Zr_{1.7}W_{0.3}O₁₂ (where 1.7≤δ≤2.5), Li_{5.39}Ga_{0.5+δ}La₃Zr_{1.7}W_{0.3}O₁₂ (where 0≤δ≤1.11), lithium phosphorous sulfide (Li₃PS₄), lithium tin sulfide (Li₄SnS₄), lithium phosphorous sulfur chloride iodide (Li₆PS₅Cl_{0.9}I_{0.1}), lithium tin phosphorus sulfide (Li₁₀SnP₂S₁₂), Li₂S, Li₂S-P₂S₅, Li₂S-SiS₂, Li₂S-GeS₂, Li₂S-B₂S₅, and Li₂S-Al₂S₅.

4. The organic-inorganic composite solid polymer electrolyte of claim 1, wherein the inorganic lithium ion conductor comprises a garnet ceramic represented by Formula 3 or an aluminum-doped ceramic represented by Formula 4:
LiₓLa_{y}Zr_{z}O₁₂ Formula 3
wherein, in Formula 3, 6<x<9, 2<y<4, and 1<z<3.
LiₓLa_{y}Zr_{z}Al_{w}O₁₂ Formula 4
wherein, in Formula 4, 5<x<9, 2<y<4, 1<z<3, and 0<w<I.

5. The organic-inorganic composite solid polymer electrolyte of claim 1, wherein an average particle diameter of the inorganic lithium ion conductor is in a range of about 10 nanometers (nm) to about 30 micrometers (μm).

6. The organic-inorganic composite solid polymer electrolyte of claim 1, wherein an amount of the inorganic lithium ion conductor is in a range of about 30 weight % (wt %) to about 90 wt %, based on a total weight of the inorganic lithium ion conductor and the copolymer.

7. The organic-inorganic composite solid polymer electrolyte of claim 1, wherein the urethane-containing polyfunctional acrylic monomer comprises diurethane dimethacrylate, diurethane diacrylate, or a combination thereof.

8. The organic-inorganic composite solid polymer electrolyte of claim 1, wherein the urethane-containing polyfunctional acrylic monomer comprises diurethane dimethacrylate represented by Formula 1: 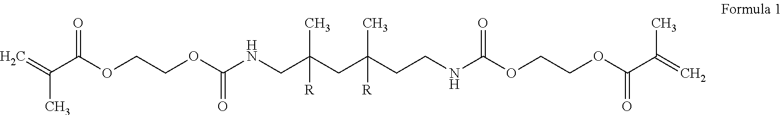
wherein, in Formula 1, each R is independently a hydrogen atom or a C1-C3 alkyl group.

9. The organic-inorganic composite solid polymer electrolyte of claim 1, wherein the polyfunctional block copolymer comprises a (meth)acrylate group at both ends and comprises a diblock copolymer or triblock copolymer comprising a polyethylene oxide repeating unit and a polypropylene oxide repeating unit.

10. The organic-inorganic composite solid polymer electrolyte of claim 1, wherein the polyfunctional block copolymer comprises a polymer represented by Formula 2: 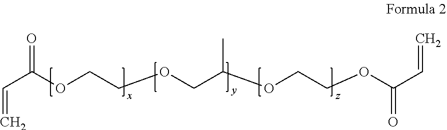
wherein, in Formula 2, x, y, and z are each independently an integer of 1 to 50.

11. The organic-inorganic composite solid polymer electrolyte of claim 1, wherein a weight average molecular weight (Mw) of the polyfunctional block copolymer is in a range of about 500 to about 20,000.

12. The organic-inorganic composite solid polymer electrolyte of claim 1, wherein a weight ratio of the urethane-containing polyfunctional acrylic monomer and the polyfunctional block copolymer is in a range of about 1:100 to about 100:1.

13. The organic-inorganic composite solid polymer electrolyte of claim 1, wherein a weight ratio of the urethane-containing polyfunctional acrylic monomer and the polyfunctional block copolymer is in a range of about 1:10 to about 10:1.

14. The organic-inorganic composite solid polymer electrolyte of claim 1, wherein the lithium salt comprises at least one selected from LiSCN, LiN(CN)₂, LiCLo₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂.

15. The organic-inorganic composite solid polymer electrolyte of claim 1, wherein an amount of the lithium salt is in a range of about 1 wt % to about 50 wt %, based on a total weight of the copolymer and the lithium salt.

16. An integrated electrode structure comprising:
a lithium metal electrode; and
the organic-inorganic composite solid polymer electrolyte of claim 1 located on the lithium metal electrode.

17. An electrochemical device comprising:
the organic-inorganic composite solid polymer electrolyte of claim 1.

18. A method of preparing the organic-inorganic composite solid polymer electrolyte of claim 1, the method comprising:
preparing a precursor mixture comprising an inorganic lithium ion conductor, a crosslinkable precursor comprising a urethane-containing polyfunctional acrylic monomer and a polyfunctional block copolymer, and a lithium salt; and
applying and curing the precursor mixture in a film form.

19. The method of claim 18, wherein the urethane-containing polyfunctional acrylic monomer comprises diurethane dimethacrylate, diurethane diacrylate, or a combination thereof.

20. The method of claim 18, wherein the urethane-containing polyfunctional acrylic monomer comprises diurethane dimethacrylate represented by Formula 1: 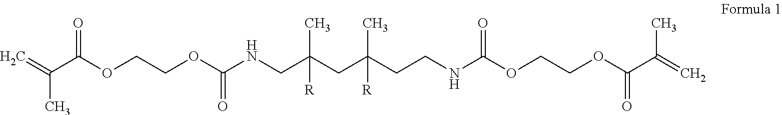
wherein, in Formula 1, each R is independently a hydrogen atom or a C1-C3 alkyl group.

21. The method of claim 18, wherein the polyfunctional block copolymer comprises an acrylate group at both ends and comprises a diblock copolymer or triblock copolymer comprising a polyethylene oxide repeating unit and a polypropylene oxide repeating unit.

22. The method of claim 18, wherein the polyfunctional block copolymer comprises a polymer represented by Formula 2: 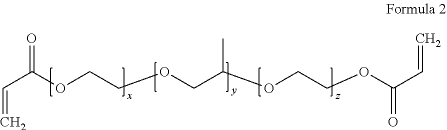
wherein, in Formula 2, x, y, and z are each independently an integer of 1 to 50.

23. The method of claim 18, wherein the curing is performed using UV, heat, or high-energy radiation.
